(19) United States
(12) Patent Application Publication
(10) Pub. No.: US 2018/0131468 A1
(43) Pub. Date: May 10, 2018

(54) FORMAT FOR SELF-SCHEDULED RESOURCE ALLOCATION

(71) Applicant: Telefonaktiebolaget LM Ericsson (publ), Stockholm (SE)

(72) Inventors: Ricardo Blasco Serrano, Stockholm (SE); Stefano Sorrentino, Solna (SE); Hieu Do, Järfälla (SE)

(21) Appl. No.: 15/570,665

(22) PCT Filed: May 4, 2016
(86) PCT No.: PCT/SE2016/050407

§ 371 Date: Oct. 30, 2017

Related U.S. Application Data
(60) Provisional application No. 62/158,066, filed on May 7, 2015.

(51) Int. Cl. H04L 1/00

(52) U.S. Cl. CPC H04L 1/0079; H04L 1/0061; H04W 76/14; H04L 1/0025; H04L 1/0091

(57) ABSTRACT

There is disclosed a method for operating a radio node, the radio node being adapted for Device-to-Device (D2D) communication. The method comprises transmitting a data packet, the data packet comprising control information and data, the control information pertaining to the data. The disclosure also pertains to associated methods and devices.

### TECHNICAL FIELD

The present disclosure relates generally to the resource management of radio communication networks with the participation of vehicles.

### BACKGROUND

The concept of device-to-device (D2D) communication becomes increasingly popular, and opens a wide range of use cases, in particular in the context of vehicular communication. However, D2D communication as suggested, coupled to network infrastructure, respectively sharing (time/frequency) resources with cellular communication, may have limitations regarding some use cases, in particular regarding desired latency times.

### SUMMARY

It is an object of the present disclosure to provide approaches for managing or utilising radio resources (time/frequency resources) for D2D communication in an efficient manner, in particular allowing low latency times for messaging, e.g. in the context of V2X communication.

There is disclosed a method for operating a radio node, the radio node being adapted for D2D communication. The method comprises transmitting a data packet, the data packet comprising control information and data, the control information pertaining to the data.

Moreover, there is described a method for operating a radio node, the radio node being adapted for D2D communication. The method comprises decoding a data packet, wherein the data packet may comprise control information and data, the control information pertaining to the data.

The data packet may comprise at least one control field and at least one data field. It may be considered that the at least one control field and/or the control information is encoded for error checking and/or error detection. A first control field may contain control information pertaining to a second control field and/or a data field. Control information may generally indicate one or more transmission parameters and/or radio resources used or intended for use for transmitting the data or data field.

Transmitting may comprise encoding the control information and/or data, in particular encoding one or more control fields and/or data fields. Different fields may be encoded differently.

Decoding may comprise decoding of a data field of the data packet based on control information indicated by or in, and/or contained in, one or more control fields of the data packet. It may be considered that decoding of a control field of the data packet comprises blind decoding of a control field of the data packet.

Further, a radio node for a wireless communication network is described. The radio node is adapted for D2D communication. Moreover, the radio node is adapted for performing any one method, or any combination of methods, of operating a radio node as discussed herein.

There is also proposed a program product comprising code executable by control circuitry, the code causing the control circuitry to carry out and/or control any one method or any combination of methods for operating a radio node described herein.

A carrier medium arrangement may also be considered. The carrier medium arrangement carries and/or stores a program product as described herein and/or code executable by control circuitry, the code causing the control circuitry to perform and/or control any one method or any combination of methods for operating a radio node described herein.

The approaches described herein pertain to a self-contained data packet including control information allowing decoding of its data content without requiring additional transmissions indicating e.g. resource allocation or encoding/modulation of the data. Accordingly, signaling overhead is limited and latency related to the data packet (e.g., from sending to decoding it) is low.

### BRIEF DESCRIPTION OF THE DRAWINGS

The drawings are provided to illustrate concepts and approaches of the disclosure and are not intended as limitation. The drawings comprise:

FIG. 1, showing example V2x scenarios for an LTE-based network (NW);

FIG. 2, showing an arrangement of data fields;

FIG. 3, showing an exemplary encoding procedure;

FIG. 4, showing an exemplary decoding procedure;

FIG. 5, showing a time-frequency grid divided into basic units;

FIG. 6, showing another time-frequency grid divided into basic units;

FIG. 7, showing a flow diagram for a blind decoding method;

FIG. 8, showing control information in a resource grid;

FIG. 9, schematically showing a user equipment as example of a radio node; and

FIG. 10, schematically showing a network node as example of a radio node.

### DETAILED DESCRIPTION

During Release 12, the LTE standard has been extended with support of device to device (D2D, also specified as “sidelink”, also called ProSe) features targeting both commercial and Public Safety applications. Some applications enabled by Rel-12 LTE are device discovery, where devices are able to sense the proximity of another device and associated application by broadcasting and detecting discovery messages that carry device and application identities. Another application consists of direct communication based on physical channels terminated directly between devices.

One of the potential extensions for the device to device work consists of support of V2x communication (which may be implemented as a form of D2D communication), which includes any combination of direct communication between vehicles, pedestrians and infrastructure. Like D2D on a general level, V2x communication may take advantage of a NW infrastructure, when available, but at least basic V2x connectivity is preferred to be possible even in case of lack of coverage. Providing an LTE-based V2x interface, in particular in the context of D2D, may be economically advantageous because of the LTE economies of scale and it may enable tighter integration between communications with the NW infrastructure (V2I) and V2P (Vehicle-to-Person) and V2V (Vehicle-to-Vehicle) communications, as compared to using a dedicated V2x technology.

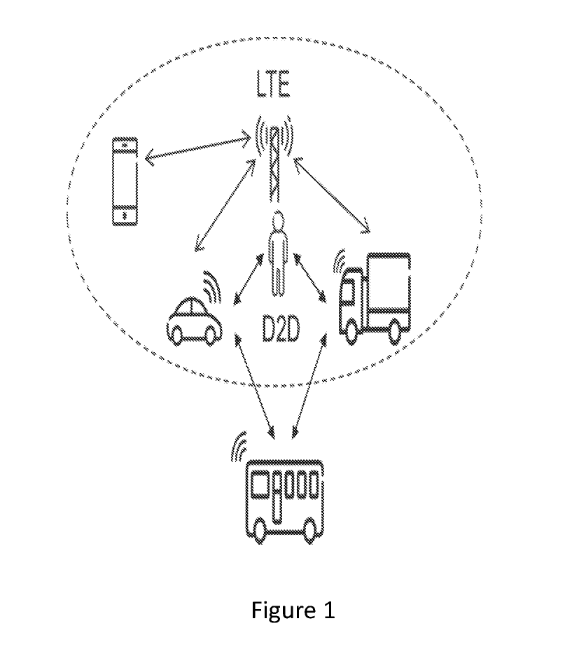

FIG. 1 shows example V2x scenarios for an LTE-based NW.

V2x communications may carry both non-safety and safety information, where each of the applications and services may be associated with specific requirements sets, e.g., in terms of latency, reliability, capacity, etc. ETSI has defined two types of messages for road safety: Co-operative Awareness Message (CAM) and Decentralized Environmental Notification Message (DENM).

CAM: The CAM message is intended to enable vehicles, including emergency vehicles, to notify their presence and other relevant parameters in a broadcast fashion. Such messages target other vehicles, pedestrians, and infrastructure, and are handled by their applications. CAM message also serves as active assistance to safety driving for normal traffic. The availability of a CAM message is indicatively checked for every 100 ms, yielding a maximum detection latency requirement of <=100 ms for most messages. However, the latency requirement for Pre-crash sensing warning is 50 ms.

DENM: The DENM message is event-triggered, such as by braking, and the availability of a DENM message is also checked for every 100 ms, and the requirement of maximum latency is <=100 ms.

The package size of CAM and DENM message varies from 100+ to 800+ bytes, a typical size is around 300 bytes. The message is supposed to be detected by all vehicles in proximity. The SAE (Society of the Automotive Engineers) also defined the Basic Safety Message (BSM) for DSRC with various messages sizes defined.

According to the importance and urgency of the messages, the BSMs are further classified into different priorities.

With the current D2D specifications, it is necessary to transmit a scheduling assignment (SA) packet prior to the transmission of the actual data packet. The SA packet contains information that allows the receiver to process (in particular, decode) correctly the data packet. However, this approach has two major drawbacks: first, it is necessary to dedicate specific resources for broadcasting the SA packets; and second, the latency is increased because it is necessary to decode the SA prior to the data packets in order to obtain the message (e.g. by decoding the data packets based on the content of the SA). Alternative approaches based on blind decoding (e.g., testing all possible RA hypotheses for a best or good enough fit) of the data packets at the receiving UE result in large computational demands for all but the simplest configurations.

There are described approaches of multiplexing and/or combining resource allocation control information that is necessary for decoding a packet (of data/user data) and the packet itself on resources, wherein the resources may be at least partly overlapping in time, and/or be continuous and/or neighboring in time. The control information and the data may be encoded into different fields (in particular using different encodings), e.g. in a cascade fashion. In some embodiments implementation may comprise reusing existing uplink control signaling.

Resources (which may be physical layer resources) may generally be radio resources comprising time resources and/or frequency resources. Frequency resources may be provided and/or defined according to a given standard, e.g. LTE, and/or may be organized or divided into frequency units or intervals, e.g. carriers, sub-carriers, frequency bands, etc. Time resources may generally be divided into time-intervals of pre-determined (e.g., by a standard used like LTE) length, e.g. frames, subframes, slots, etc. Resources for transmission may generally comprise time-frequency resources, which may comprise at least one time resource (e.g., slot or subframe), and at least one frequency resource, e.g. a subcarrier, and/or a resource element or resource block (e.g., a time slot and 12 subcarriers).

These approaches allow for decoding packets transmitted directly between devices (D2D, V2V, etc.) without needing or lowering the need to dedicate time resources for broadcasting of resource allocations, which may lead to reduced latency and minimizing of the corresponding overhead in terms of radio resource utilization.

Moreover, utilizing variable formats for the control fields used for resource allocation is allowed, which may improve the flexibility and/or the reliability of a resource allocation process.

The need for performing blind decoding of data packets may be reduced or eliminated. Also, the probability of decoding a data packet may be increased compared to alternative methods that require decoding a scheduling assignment in addition to the data packet or blind detection methods.

In some embodiments, encoding/decoding/interleaving implementations or parts thereof from existing LTE uplink control signaling may be utilized, thus reducing implementation cost.

In cellular communications, and in some D2D modes, a control node or base station like an eNB (and called eNB further on as a representative of a control node or base station; accordingly eNB may be interchanged with base station or control node) usually manages the resources used, in particular the resources in the cell/s, in particular those cells associated to the eNB. For uplink transmissions, this means that the eNB allocates resources to different UEs, which may be connected or associated to the cell/s. For the purpose of this disclosure, the process of resource allocation (RA) to a specific UE can be divided into two steps. In the first step, a set of radio resources (e.g., time slot/s and frequency band/s) to be used by the UE is chosen or determined, e.g. by the eNB or control node, as well as other transmission parameters such as power or transport format (TF). In the second step, the appropriate control signaling is used to inform other participants of the communication, e.g. the UE, about the details of the allocation and/or one or more UEs may be configured accordingly.

Following the instructions included in the control signaling, e.g. of the eNB, the UE can transmit a data packet in the uplink in a way that can be understood by the receiver (e.g., the eNB). For downlink transmissions, the process is slightly different since both the RA and the data packet transmission are carried by the eNB (here it may be assumed that D2D transmissions correspond to uplink transmission, e.g. to another terminal or UE as the target/receiver instead of the eNB). Nevertheless, it is still necessary to convey the RA control information to the appropriate UEs to configure them accordingly, so that they process the downlink transmissions in the correct manner to decode the data packet (i.e., tune in the right frequency at the right time, apply the corresponding decoding algorithm, etc.). Thus, the resource allocation process may comprise at least these two steps (determining and configuring) for enabling the exchange of data packets between the UE and the eNB or other UE/s. Moreover, the existence of a control or master node (e. g., the eNB) that coordinates all cellular communications simplifies the process of RA.

However, for reasons that need not be discussed herein, future V2V communication systems may have to be able to operate in areas without cellular coverage. D2D communications are currently under study/standardization as a technology enabler for such V2V communication systems. Thus, new mechanisms that allow devices to carry out the process of RA in a different way may be useful, in particular without the aid of an eNB.

One possibility is to perform the RA process at the UE or a node in a new way. That is, the UE or node (which may be a radio node) may determine and/or decide and/or allocate, and/or be adapted for, and/or comprise a resource module for, determining and/or deciding and/or allocating, e.g. locally, radio resources, e.g. a set of radio resources, to utilize, and/or transmission parameters, e.g. the transport format, and/or the transmission power, etc., to utilize for transmission, in particular for itself and/or transmission performed by itself. In doing so, the UE or node may dispense with the NW dependency. In addition, it may also be able to apply information (e.g., obtained through some measurements) about the local usage of the radio resources and/or operation conditions, in particular something that may not trivially available to an eNB.

Transmission parameters may in particular comprise and/or indicate an encoding (e.g., for error detection and/or forward error correction) and/or modulation to be used for transmission, in particular data transmission. If an encoding is indicated, decoding may be performed based on such indication, as a reversing of the encoding.

Generally, determining and/or deciding and/or allocating radio resources and/or transmission parameters may be based upon operation conditions, in particular transmission and/or reception conditions, determined and/or measured by the UE or node, e.g. Signal-to-Interference and/or Noise Ratio (SNR and/or SINR), channel state information and/or channel quality information. Generally, determining and/or deciding and/or allocating (e.g., of radio resources and/or transmission parameters) may include receiving corresponding information, e.g. from another node, in particular receiving corresponding allocation data; a UE or node may be thus configured or configurable.

Alternatively or additionally, determining and/or deciding and/or allocating may be performed by the UE or node itself, e.g. based on operation conditions and/or without connection to a network and/or control node like a base station or eNB, in particular without resources and/or a resource pool having been allocated and/or configured to it and/or not being based on such resources and/or such a pool.

It may be considered that determining and/or deciding and/or allocating radio resources and/or transmission parameters includes determining and/or deciding and/or allocating radio resources and/or transmission parameters for different fields of a data packet, in particular such that the resources and/or parameters for different fields differ from each other. For example, there may be provided and/or pre-determined sets of transmission parameters and/or resources or combinations thereof available for certain fields, and determining and/or deciding and/or allocating radio resources and/or transmission parameters may include choosing from the associated set for a field, in particular choosing a combination of parameters and/or resources, which may define each parameter or resource uniquely.

The sets of transmission parameters may be differing in size (representing the number of possible different combinations of resources and/or parameters available for the field). In particular, the size of a set associated to a data field may be smaller than the size of a set associated to a control field. This may allow quick blind decoding on a control field (see below for the definition of the fields). There may be provided mappings between sets providing relations, such that from a chosen combination of transmission parameters and/or resources for one field, a subset of available combinations for one or more other fields is derivable, in particular a subset of a singular or unique combination.

A combination of parameters and/or resources may be considered unique or singular, if each parameter and/or resource is addressed in the combination is defined unambiguously and/or to a single (e.g. admissible) value. Determining and/or deciding and/or allocating radio resources and/or transmission parameters may in particular determining and/or choosing (e.g., from a corresponding set) and/or deciding on which or how many fields a data packet is to contain (e.g., at least one control field and at least one data field), and/or an encoding and/or modulation to be used for each field of a data packet to be transmitted.

Control information may generally comprise and/or indicate radio resources (for transmission, in particular of data/user data) and/or transmission parameters, in particular pertaining to the transmission of data/user data. Data or user data may generally pertain to information transmitted and/or to be transmitted as payload, with resources and/or transmission parameters, wherein the resources and/or parameters may be indicated by and/or associated or corresponding to the control information. Indicating some information, e.g. control information and/or resources and/or (e.g., transmission) parameters, may generally include containing and/or providing information allowing deducting of the indicated information, in particular control information and/or resources and/or (e.g., transmission) parameters. Control information pertaining to transmission parameters and/or resources may indicate the transmission parameters and/or resources it is pertaining to.

Operation conditions may comprise transmission and/or reception conditions, and/or be determined and/or measured by the UE or node. For example, operation conditions may comprise and/or indicate SNR and/or SIR (Signal-to-Interference) and/or SINR (Signal-to-Interference-and-Noise), and/or channel conditions and/or channel state or quality information (CSI and/or CQI), received power (e.g., as measured in a receiver of the UE or node), and/or signal strength (e.g., pilot signal strength, and/or path-loss information and/or distance to one or more targets (e.g., a target UE or node), etc.

Establishing one-to-many D2D communications (e.g., multicast and/or broadcast) may be challenging from an RA point of view. In particular, it the decoders (targets of transmissions) should know the (transmission) parameters used for encoding the data packet (e.g, TF, time-frequency resources, etc.). The simplest solution to this problem is not to signal this control information and leave the task of finding it out to the receiver/decoder/target. This simplifies the communication protocol and the structure of the transmitter, but places a heavy computational burden on the receiver.

That is, the receiver/decoder/target usually needs to try all possible hypotheses (i.e., combinations of TF, time-frequency resources, etc.) until it finds one that produces a valid output. Since the number of hypotheses grows exponentially with the number of parameters (TFs, bands etc.), this blind decoding approach is typically prohibitively complex for all but the simplest systems (i.e., with very few candidate hypotheses).

In alternative solutions, the transmitter may inform explicitly the receivers about the parameters (indication the resources and/or transmission parameters) used to transmit the data packet. This is analog to Step 2 of the eNB-centric RA process, as described above. One possibility is to dedicate some special resources for broadcasting RA messages containing the necessary control information. That is, each UE uses a special procedure to notify the rest of the UEs about its intention to transmit using some specific transmission parameters. This solution requires little computational effort compared to the blind decoding approach. However, dedicating specific resources for transmitting RAs usually leads to an inefficient usage of the radio resources. In addition, this method is inherently less reliable since a message will be correctly decoded only if both the RA message and the data packet are correctly decoded (as opposed to a single packet being decoded with the blind decoding approach). This is particularly critical for the case of V2x applications which are broadcast by nature and take place in very challenging conditions (e.g., high UE speeds, no line of sight, rapidly changing propagation conditions, etc.). The Release 12 specifications for LTE-D2D use this alternative for signaling RAs.

A further possibility or approach is to include the control information with the transmission parameters and/or control information in the data packet. It is, however, important to note that the appended control information cannot be treated in the same way as the rest of the payload (data) because knowledge of this information is necessary to decode the rest of the packet. In other words, if the control information is added to the transmitted packet, then it must be possible to decode it without any further help. Although it is still necessary to dedicate some transmission resources to convey the control information, this method is more efficient than transmitting separate RAs since some control signals (e.g, reference signals) are shared by the control information and the data packet. In addition, decodability depends only on a single transmission.

This last approach is proposed to convey the control information necessary for decoding the message.

Control information (and/or a member of a set of transmission parameters) may generally include (but is not restricted to) any of the following: transport format (encoding and/or modulation and/or transport block size, modulation and coding scheme, and/or antenna mapping) (as an example of transmission parameters), starting/ending frequency (and/or carriers, as examples for resources), bandwidth (as an example of resources), starting/ending time (as an example of resources), frequency hopping pattern (as an example of resources), time hopping pattern (as an example of resources), retransmission number (as an example of transmission parameters), and/or redundancy version (as an example of transmission parameters), new data indication (NDI) (as an example of transmission parameters), DMRS format indication (as an example of transmission parameters), etc. Any such collection (or a subset thereof) of parameters or control information identifying a transmission format or a part thereof, in particular for data or a data field, may be referred to as the Data Packet Transmission Format (DPTF). To carry this control information along with the actual data, a data packet transmitted may contain one or more control fields in addition to at least one data field. The control fields and the data field may be transmitted on resources that are at least partly overlapping in time. A format or transport format may indicate at least a coding/encoding and modulation.

Fields transmitted on resources that are at least partly overlapping in time may be fields sharing at least one time resource (e.g., transmitted at least partly at the same time) and/or transmitted at neighbouring and/or abutting time units, intervals or divisions (or sub-divisions), e.g. slots, and/or transmitted continuously and/or successively, e.g. without interrupting time division/sub-division (or interval or unit) without transmission (in particular from the same transmitter and/or radio node) or pertaining to or used for the transmission of different data or data packet and/or intended for a different receiver (in particular from the same transmitter and/or radio node). A format of a field may in particular indicate the encoding and/or modulation used for transmitting the field. Transmitting a field may refer to transmitting the information and/or bits associated to the field using the encoding and/or modulation of the field.

There is generally described method for operating a radio node (in particular a UE or control node, base station or eNB), which may be adapted for D2D communication, in particular D2D transmission, and/or a corresponding radio node. The method may comprise transmitting, e.g. by the radio node, and/or the radio node may be adapted for, and/or comprise a transmitting node for, transmitting a data packet, the data packet comprising control information and data, the control information pertaining to the data. Transmitting a data packet may be a D2D transmission.

The control information may be contained in a control field and the data may be contained in a data field. The method may (optionally) comprise determining and/or deciding and/or allocating radio resources and/or transmission parameters as described herein and/or the radio node may be adapted for, and/or comprise a resource module for, such determining and/or deciding and/or allocating.

It may be considered that the at least one control field and/or the control information is encoded for error checking and/or error detection, e.g. via a CRC mechanism.

The data packet may generally comprise at least one (e.g., a first) control field and at least one data field. A control field may generally contain control information, which may pertain to the transmission parameters and/or resources used for transmitting another field, e.g. a control field and/or a data field.

A first control field may contain control information pertaining to a second control field, if present, and/or a data field. A second control field, if present, may contain control information pertaining to a third control field, if present, and/or the data field. A third control field, if present, may contain control information pertaining to a fourth control field, if present, and/or the data field, etc.

A data field may contain data, wherein the control information (of one or more control fields) may pertain to the data field, in particular indicate one or more transmission parameters and/or radio resources used or intended for use for transmitting the data or data field. To each field there may be associated time-frequency resources and/or transmission parameters with or within which they are transmitted (as opposed to control information which may actually be in a field transmitted with resources and/or transmission parameters not indicated by the control information), in particular pertaining to encoding and/or modulation.

Generally, different fields may differ in the transmission parameters and/or radio resources pertaining to them and/or with which they are transmitted, in particular regarding encoding and/or modulation. Also, alternatively or additionally, control information pertaining to another field may be derivable from and/or encoded in and/or mappable from transmission parameters and/or resources used for transmitting the field, e.g. based on pre-defined relations of parameters and/or resources, e.g. mapping between sets of parameters and/or resources available for the different fields. It may be considered that the time-frequency resources for control information, e.g. used for transmitting one or more control fields, may provide a mapping to the time-frequency resources of another control field and/or a data field. Determining and/or deciding and/or allocating may be based upon and/or consider such a mapping or a corresponding function or table providing such a mapping, which may be pre-determined.

It should be noted that transmission parameters and/or resources with, for or at which a field is transmitted pertain to the actual parameters and resources used for transmitting the field (or the corresponding data), whereas control information in a control field may pertain to transmission parameters and/or resources used for transmitting one or more different fields. Each field may generally have associated to it a number of bits it may contain, wherein the bits may be representing the information to be contained in the field (e.g., control information or data, respectively).

The bits in a field may be encoded and/or modulated for transmission. The data field/s may be encoded and/or modulated and/or transmitted according to the DPTF, which may be represented or indicated by control information in one or more control fields. Alternatively or additionally, control information pertaining to the data field/s may be derivable from the transmission parameters and/or resources used for transmitting one or more control fields. The method may comprise such encoding and/or the radio node may be adapted for, and/or comprise an encoding module for, encoding. Encoding may generally comprise modulating. Optionally, encoding may comprise performing error detection encoding (e.g. a CRC, cyclic redundancy check) on control information, e.g. individually on one or more control fields and/or any combination of control fields, in particular on the control information in all control fields.

Transmitting a field may generally refer to transmitting the bits of the field using the associated transmission parameters and/or resources, in particular encoding and/or modulation.

For example, there may be provided 3 control fields:
The bits in Field 1 may contain an identifier of the format used in the encoding of Field 2.
The bits in Field 2 may contain an identifier of the format used in the encoding of Field 3.
The bits in Field 3 may carry information about the DPTF used to transmit the Data Field.
The bits in the Data Field carry the message payload (i.e., the data or used data or information to be transmitted in the data packet), which is encoded as specified by the DPTF.

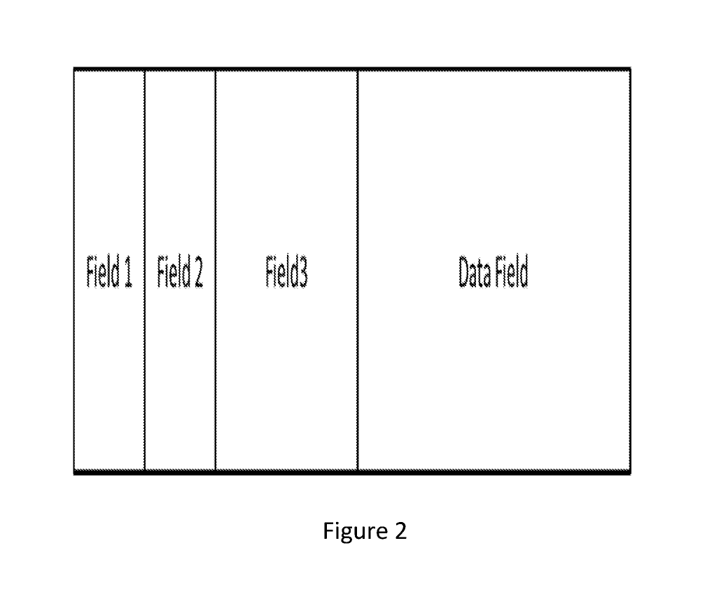

The four different fields are illustrated in FIG. 2.

The use of Fields 2 and/or 3 is optional. That is, in a simple embodiment, Field 1 carries all the information about the DPTF for the Data Field while Fields 2 and 3 are absent. In a more sophisticated embodiment, Field 2 is present and contains information about the DPTF for the Data Field while Field 3 is absent. The approach can be extended to an arbitrary number of fields (in particular, an arbitrary number of control fields) applying similar principles, resulting in different performance/flexibility trade-offs.

Moreover, the approach covers the case in which all available information may be used to decode a Field. For example, the DPTF of the Data Field may be specified by all the bits in Fields 1-3 and not only by those in Field 3.

An important advantage of the approach is that it allows adapting the transmission format for some of the control fields without increasing the number of blind decodes. The transmission format of such control fields may be derived at least based on the transmission format of the associated data.

The method may comprise, and/or the radio node may be adapted for and/or comprise an encoding module for, encoding the message or data packet (in particular before transmitting and/or after and/or based on determining and/or deciding and/or allocating transmission parameters and/or resources), e.g. according to the following procedure:

1. The data bits (i.e., information payload) are encoded according to the specifications of the DPTF chosen for transmission.
2. The bits identifying the DPTF (representing control information) are treated as Field 3 bits and are encoded according to the specifications of a chosen Field 3 format.
3. The bits identifying the chosen Field 3 format (representing control information) are treated as Field 2 bits and are encoded according to the specifications of a chosen Field 2 format.
4. The bits identifying the chosen Field 2 format (representing control information) are treated as Field 1 bits and encoding correspondingly. For transmitting, the following optional steps may be performed:
5. The coded bits resulting from Steps 1, 2, and 3 may be multiplexed and mapped onto constellation symbols.
6. The coded bits resulting from Step 4 may be multiplexed and mapped onto constellation symbols.
7. The constellation symbols resulting from Steps 5 and 6 may be mapped onto physical resources.

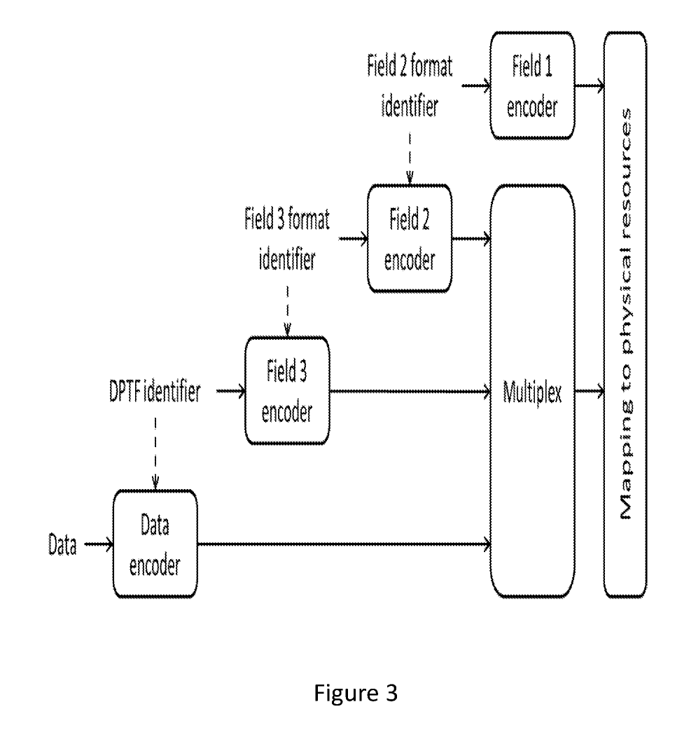

This exemplary encoding procedure is illustrated in Error! Reference source not found. FIG. 3.

As described above, the approach covers the case where any of the bits used in previous steps is used for encoding the field in the current step.

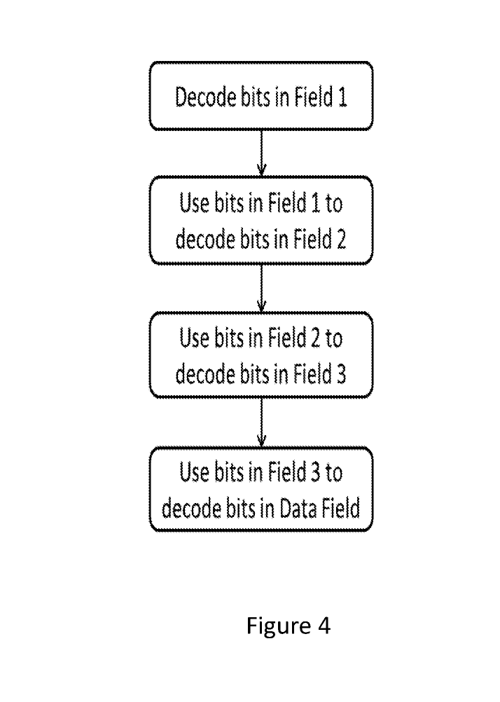

A receiving node or UE may decode the transmitted message e.g. as illustrated in FIG. 4 and described in the following steps:
1. The UE decodes the bits in Field 1.
2. Using the bits decoded in Step 1, the UE decodes the bits in Field 2.
3. Using the bits decoded in Step 2, the UE decodes the bits in Field 3.
4. The bits obtained in Step 3 contain the necessary control information to decode the data field.

As described above, the approach covers the case where any of the bits used in previous steps is used for decoding the field in the current step.

Generally, there is described a method for operating a radio node, in particular a UE, wherein the radio node may be adapted for D2D communication, in particular D2D reception. There is also disclosed a corresponding radio node. The method may comprise, and/or the radio node may be adapted for and/or comprise a decoding module adapted for, decoding a data packet, wherein the data packet may comprise control information and data, the control information pertaining to the data. The data packet may any of the data packets described herein, in particular may comprise at least one control field and at least one data field, which may be fields as described herein. Decoding of the data field may be performed based on control information indicated by or in and/or contained in the one or more control fields. Decoding of a control field may be based on control information indicated by and/or contained in another control field. Additionally or alternatively, decoding may be based on sets of transmission parameters and/or resources and/or combinations thereof, which may be predetermined. Decoding of a control field may comprise blind decoding, in particular based on a set of transmission parameters and/or resources. The set of transmission parameters and/or resources may be the same as the set used for transmission and/or determined and/or decided and/or allocated by the radio node transmitting the data packet, and/or may correspond thereto, e.g. allowing reversal of modulation and/or encoding (by e.g. providing a decoding corresponding to the encoding used). Generally, decoding may comprise demodulating. Decoding may be based on relations between sets associated to the fields, e.g. as outlined herein regarding transmitting respectively determining and/or deciding and/or allocation resources and/or parameters (which generally refers to radio resources and/or transmission parameters).

A data packet (transmitted or received) may generally represent and/or be provided or transmitted in a D2D transmission, e.g., without being relayed via a network node like an eNodeB. A data packet may be considered to represent and/or contain a message, in particular a V2X or V2V or V2l message, and/or a CAM or DENM or BSM message. The latter may be considered as examples of V2X or V2V messages. Such a message (respectively its content) may represent data, which may be contained in a data field comprising additional control information in one or more control fields.

Generally, pre-determined information, e.g. sets as described herein, may be information defined by a standard and/or configured, e.g. by a network or base station or eNB, and/or received from another node like a control node, and/or be stored in a memory of the respective radio node and/or accessible to control circuitry of the node.

Using the different control fields it is possible to provide support for scheduling a large number of DPTFs with different degrees of reliability. For example, in one embodiment a bit in Field 2 may be used to specify whether retransmissions are used or not. If retransmissions are being used, some of the bits in data Field 3 may specify the retransmission number. If retransmissions are not being used, the same bits in data Field 3 may be used to provide another type of information or may be used to provide additional redundancy to the rest of Field 3 bits, thus improving reliability. Some values in some fields may be reserved for indication of formats to be used in future releases or future applications.

In one embodiment, an implementation using the following existing uplink control signaling mechanisms in LTE may be considered. The current 3GPP standard for LTE provides a way of conveying Layer 1/Layer 2 (L1/L2) control information for uplink transmissions, multiplexed in time and frequency with the data. In the 3GPP Release 12 standard, there are three different fields (which do not correspond to the control fields above, but may be included into them) to carry control information:
A field carrying HARQ acknowledgements for downlink transmissions. This field can be decoded without any knowledge of the format used in any of the other fields. These bits would be used as Field 1 bits in this embodiment.
A field carrying a multi-antenna transmission parameter known as the rank indicator (RI). To decode the RI, it is necessary to know the rate matching pattern used for encoding the data. In the case of cellular uplink communications, the receiver (i.e., the eNB) knows exactly how the data was encoded because the rate matching pattern is indeed selected by the eNB. These bits would be used as Field 2 bits in this embodiment.
A field carrying an additional multi-antenna transmission parameter (precoding matrix indicator or PMI) and channel reports (channel quality information or CQI). To decode them it is necessary to know the rate matching pattern used for encoding the data and also to know the value of the RI. That is, the eNB needs to decode first RI and then, PMI/CQI. These bits would be used as Field 3 bits in this embodiment.

In addition to these three fields carrying L1/L2 control information, the uplink packet carries other fields with other types of signals. Among these, the PUSCH (Physical Uplink Shared Channel), which carries the actual information payload or data, mentioned. PUSCH bits would be used as Data Field bits in this embodiment. The rate matching pattern use for these bits would be identified by the Field 1 bits in this embodiment. Since most of the receiver and implementation complexity derives from decoding or detection rather than deinterleaving/demapping, reusing control information encoding mechanisms similar to LTE with new control information scheduling and mapping/interleaving schemes could result in significant implementation effort reduction in the devices.

In some embodiments, Field 1 may only be present in small set of time-frequency resources. This is illustrated in Figure. This set may be preconfigured in the UE or configured semi-statically by the NW and communicated to the UE while in coverage. In such cases, the UE may obtain a candidate DPTF from each position and attempt to decode a Data Field. Internal control mechanisms (e.g., a CRC) of the Data Field may be used to decide whether the decoded bits constitute a valid Data Field or not.

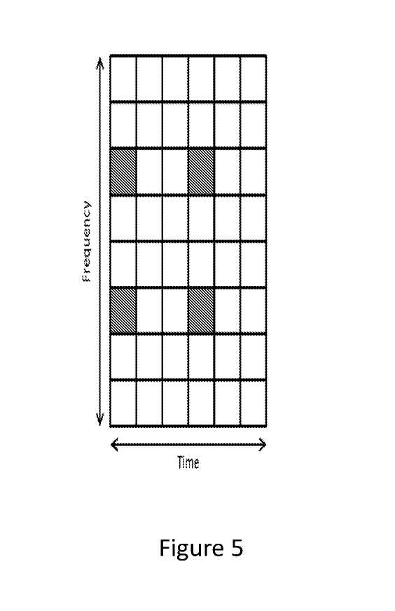

FIG. 5 shows a time-frequency grid divided into basic units (e.g, LTE physical resource blocks). The control information may only be present in the few resource units/blocks that are shadowed.

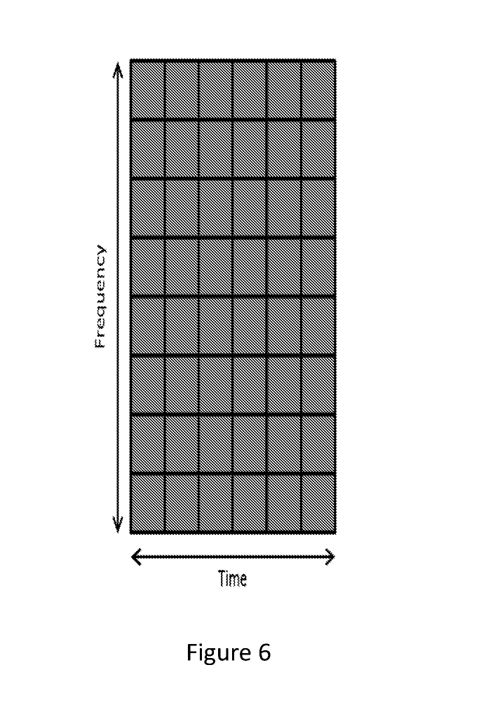

FIG. 6 shows a time-frequency grid divided into basic units (e.g, LTE physical resource blocks). The control information may be present in any of the resource units/blocks. In some other embodiments, Field 1 may be present anywhere in the time-frequency grid or may be restricted to a large set of time frequency resources. This is illustrated in FIG. 6.

A check mechanism (e.g, a CRC code) may be included for the control information. The UE may thus attempt to decode all candidate DPTFs (i.e., perform blind decoding on the control information) and only proceed to decode Data Fields for those candidate DPTFs that pass the check test.

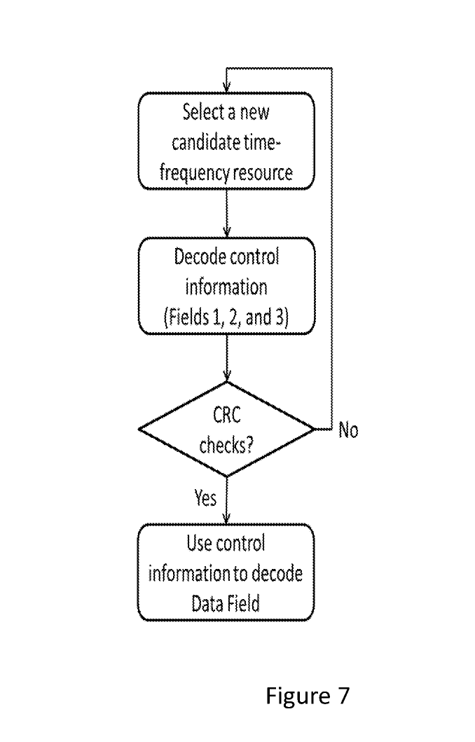

This process is illustrated in FIG. 7. Check mechanisms may be used for Fields 1-3 individually or in groups. For example, having a check mechanism after Field 1 allows stopping the process much earlier, thus reducing the decoding effort. In any case, the complexity of performing blind decoding on the control information is much smaller than that of performing blind decoding on the whole package (i.e., trying all possible DPTFs until one yields a valid Data Field).

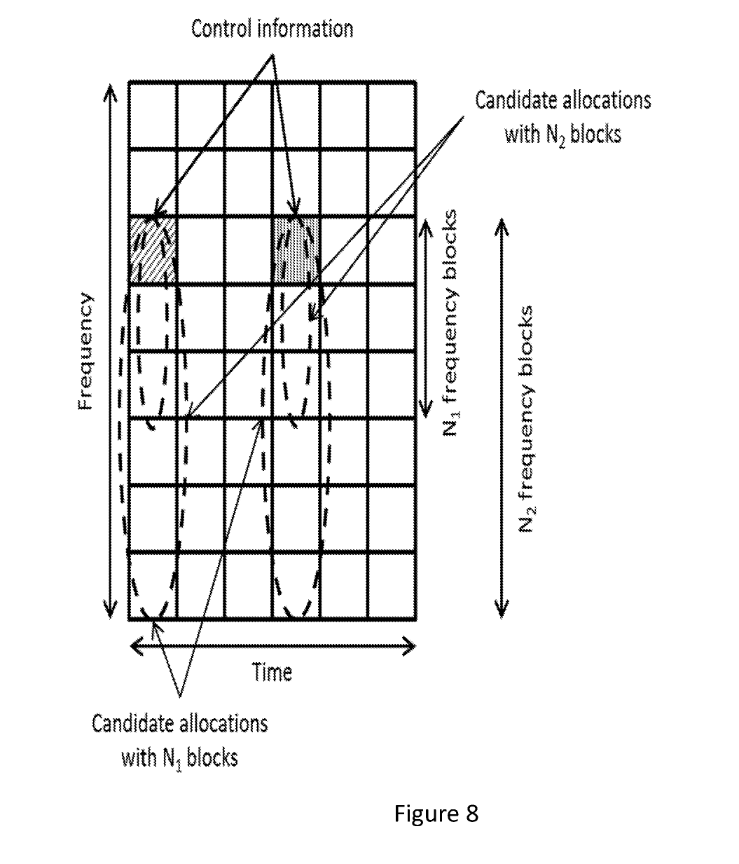

In some embodiments, the position of the control information in the time-frequency grid may be used to obtain information about the position of the rest of the packet in the time-frequency grid, as an example of control information encoded or represented by the transmission parameters or resources used for transmitting the control field. For example, the control information may always be present in the time-frequency resources with smallest indices within a certain message transmission. In a further example, the control information may be always mapped to the first one or more resource blocks used for a message transmission. The receiver detects the control information and implicitly obtains the starting position in frequency for the associated data message. In a further example, allocations may be restricted to two sizes in frequency: N₁ and N₂. The control information may be placed in the resource block corresponding to the smallest frequency. After obtaining the DPTF, the decoder may attempt decoding a block of N₁ resources or a block of N₂ resources and use the control mechanisms in the Data Field to discard the invalid ones. This is illustrated in FIG. 8.

FIG. 8 shows the position of the control information (resource blocks with line patterns) signals in the first block in the allocation. Candidate allocation bandwidths are N₁ and N₂.

The resource allocation size (e.g., BW) for the data messages (sometimes called data channels) may be a transmission parameter. If the data resource allocation is small, there is a risk that the control information exceeds the resources allocated for data, which may result in interference with other data packets. Therefore, in one example the control field resources may be constrained by design to not exceed the resources allocated for a certain packet or message transmission. This can be obtained by limiting the rate-matching of the control fields taking into account at least the resources assigned for data.

A receiver may not be aware of the data resource allocation size (e.g., BW) until certain control fields have been decoded. Therefore, decoding and/or detection of at least some control fields may be agnostic to the resources (e.g. BW) allocated to the associated data packet. In one example, at least some control fields are rate matched and/or mapped to the resources assuming a maximum pre-defined resource size for the control information. Such resource size may match with the minimum supported data channel size. Transmitting may be based on such approach. Decoding may consider and/or be based on such approach.

From an implementation point of view, the D2D signaling used by the LTE-D2D interface is to a great extent based on cellular uplink signaling. Although the approach has been presented here in the context of LTE-based V2V communications, the approaches can be applied to any type of LTE-based D2D communications, where the packet is adapted to or needs to carry control information that is necessary for decoding the payload. Moreover, the principle is applicable to more systems than those based on LTE, although the specific implementation may differ (e.g., the embodiment that reuses the existing uplink control signaling mechanisms in LTE may not be directly applicable).

There are disclosed methods and devices to convey/transmit the control information that is necessary for decoding a packet by appending it to the packet. The control information may be encoded in different fields in a cascade fashion allowing for different tradeoffs between flexibility and reliability. In some embodiments implementation my comprise reusing existing uplink control signaling and/or a D2D communication interface.

| Abbreviation | Explanation |
|---|---|
| 3G | Third Generation of Mobile Telecommunications |
| | Technology |
| BSM | Basic Safety Message |
| BW | Bandwidth |
| CAM | Cooperative Awareness Message |
| DPTF | Data Packet Transmission Format |
| D2D | Device-to-Device Communication |
| DENM | Decentralized Environmental Notification Message |
| DSRC | Dedicated Short-Range Communications |
| eNB | eNodeB |
| ETSI | European Telecommunications Standards Institute |
| LTE | Long-Term Evolution |
| NW | Network |
| ProSe | Proximity Services |
| RA | Resource Allocation |
| RS | Reference Signals |
| TF | Transport Format |
| SAE | Society of the Automotive Engineers |
| UE | User Equipment |
| V2I | Vehicle-to-Infrastructure |
| V2P | Vehicle-to-Pedestrian |
| V2V | Vehicle-to-vehicle communication |
| V2x | Vehicle-to-anything-you-can-imagine |
| wrt | with respect to |

These and other abbreviations may be used according to LTE standard definitions.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may involve one or more than one terminal (which may be used interchangeably with user equipment) connected to a wireless communication network and/or more than one node of a wireless communication network and/or in a wireless communication network. It may be envisioned that a radio node, e.g. in or for communication, and/or in, of or for a wireless communication network is adapted for communication utilizing one or more RATs, in particular LTE/E-UTRA. A communication may generally involve transmitting and/or receiving messages, in particular in the form of packet data or a data packet.

A message or packet may comprise control information and/or payload data and/or represent and/or comprise a batch of physical layer transmissions. Control information or control data may refer to data pertaining to the process of communication and/or nodes and/or terminals of the communication. It may, e.g., include address data referring to a node or terminal of the communication and/or data pertaining to the transmission mode and/or spectral configuration and/or frequency and/or coding and/or timing and/or bandwidth as data pertaining to the process of communication or transmission, e.g. in a header.

Each node or terminal (like a UE) may comprise radio circuitry and/or control circuitry and/or antenna circuitry, which may be arranged to utilize and/or implement one or more than one radio access technologies. Radio circuitry of a node or terminal may generally be adapted for the transmission and/or reception of radio waves, and in particular may comprise a corresponding transmitter and/or receiver and/or transceiver, which may be connected or connectable to antenna circuitry and/or control circuitry. Control circuitry of a node or terminal may comprise a controller and/or memory arranged to be accessible for the controller for read and/or write access. The controller may be arranged to control the communication and/or the radio circuitry and/or provide additional services. Circuitry of a node or terminal, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered. The communication (transmission and/or reception) of a data packet may be D2D communication.

A radio node, e.g. of or for a wireless communication network, may be implemented as a terminal and/or user equipment and/or network node and/or base station (e.g. eNodeB) and/or relay node and/or any device generally adapted for communication in a wireless communication network, in particular cellular communication and/or D2D communication.

A wireless communication network or cellular network may comprise a network node, in particular a radio network node, which may be connected or connectable to a core network, e.g. a core network with an evolved network core, e.g. according to LTE. A network node may e.g. be a base station. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation.

A terminal may be implemented as a user equipment; it may generally be considered that a terminal is adapted to provide and/or define an end point of a wireless communication (in particular D2D communication and/or cellular communication) and/or for a wireless communication network. A terminal or a user equipment (UE) may generally be a device configured for wireless device-to-device communication and/or a terminal for a wireless and/or cellular network, in particular a mobile terminal, for example a mobile phone, smart phone, tablet, PDA, etc. A user equipment or terminal may be a node of or for a wireless communication network as described herein, e.g. if it takes over some control and/or relay functionality for another terminal or node. It may be envisioned that terminal or user equipment is adapted for one or more RATs, in particular LTE/E-UTRA. It may be considered that a terminal or user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. It may be considered that a terminal or user equipment is configured to be a terminal or user equipment adapted for LTE/E-UTRAN.

A control node may be a radio node, e.g. a network node or base station (e.g. eNodeB or eNB), which may be any kind of base station of a wireless and/or cellular network adapted to serve one or more terminals or user equipments. It may be considered that a base station is a node or network node of a wireless communication network. A network node or base station may be adapted to provide and/or define and/or to serve one or more cells of the network and/or to allocate frequency and/or time resources for communication to one or more nodes or terminals of a network. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in cellular communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station. A network node or base station may generally be adapted to allocate and/or schedule time/frequency resources of a network and/or one or more cells serviced by the base station. An eNodeB (eNB) may be envisioned as an example of a base station, e.g. according to an LTE standard. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a control node and/or coordinating node and/or to allocate resources in particular for cellular communication via one or more than one cell, and/or to allocate resources and/or a resource pool for D2D communication.

It may be considered for cellular communication there is provided at least one uplink (UL) connection and/or channel and/or carrier and at least one downlink (DL) connection and/or channel and/or carrier, e.g. via and/or defining a cell, which may be provided by a network node, in particular a base station or eNodeB. An uplink direction may refer to a data transfer direction from a terminal to a network node, e.g. base station and/or relay station. A downlink direction may refer to a data transfer direction from a network node, e.g. base station and/or relay node, to a terminal. UL and DL may be associated to different frequency resources, e.g. carriers and/or spectral bands. A cell may comprise at least one uplink carrier and at least one downlink carrier, which may have different frequency bands. D2D communication may be arranged such that the associated (sidelink) resources correspond to (or are shared with) uplink resources. Alternatively or additionally, the resources may correspond to (or may be shared with) downlink resources. This correspondence or sharing may be relevant in in-coverage scenarios, in which communication with a base station or network node is possible and/or D2D communication is controlled or supported by such. A network node, in particular a base station, and/or a terminal, in particular a UE, may be adapted for communication in spectral bands (frequency bands) licensed and/or defined for LTE.

Resources or communication resources may generally be frequency and/or time resources, which may comprises e.g. frames, subframes, slots, resource blocks, carriers, subcarriers, channels, frequency/spectral bands, etc. Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Transmitting on or with allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated.

Allocation data may be considered to be data indicating and/or granting resources allocated by a network node, e.g. a controlling and/or allocation node, in particular data identifying or indicating which resources are reserved or allocated, e.g. for cellular communication, which may generally comprise transmitting and/or receiving data and/or signals; the allocation data may indicate a resource grant or release and/or resource scheduling. A grant or resource grant may be considered to be one example of allocation data. It may be considered that an allocation node is adapted to transmit allocation data directly to a node and/or indirectly, e.g. via a relay node and/or another node or base station. Allocation data may comprise control information or data and/or be part of or form a message, in particular according to a pre-defined format, for example a DCI format, which may be defined in a standard, e.g. LTE. In particular, allocation data may comprise information and/or instructions to reserve resources or to release resources, which may already be allocated. A terminal may generally be adapted to perform transmission of data to, e.g. UL data, and/or reception of data from, a network node and/or to more than one network nodes, according to allocation data and/or resources and/or transmission parameters determined and/or allocated.

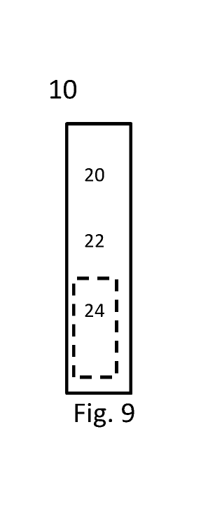

FIG. 9 schematically shows a user equipment 10. User equipment 10 comprises control circuitry 20, which may comprise a controller connected to a memory. Any module of a user equipment may implemented in and/or executable by, user equipment, in particular the control circuitry 20. User equipment 10 also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for cellular communication and/or D2D communication, in particular utilizing E-UTRAN/LTE resources as described herein. The user equipment 10 may be adapted to carry out any of the methods for operating a radio node or terminal disclosed herein; in particular, it may comprise corresponding circuitry, e.g. control circuitry.

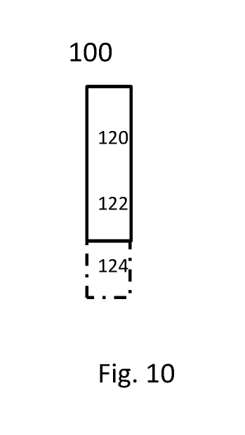

FIG. 10 schematically show a network node or base station 100 as another example of a radio node, which in particular may be an eNodeB. Network node 100 comprises control circuitry 120, which may comprise a controller connected to a memory. Any module of a network node, e.g. a receiving module and/or transmitting module and/or control or processing module and/or scheduling module, may be implemented in and/or executable by the network node, in particular the control circuitry 120. The control circuitry 120 is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a radio node disclosed herein; in particular, it may comprise corresponding circuitry, e.g. control circuitry. A radio node of a network may in particular utilize the approach disclosed above under heavy load, e.g. if a large number of UEs have to be scheduled. The present approach may in particular be useful in cases in which individual UEs with low amounts of data to transmit and/or to receive are served with the approach identified herein, e.g. with resources set aside or defined for this approach, reducing overhead. Such UEs may e.g. be devices involve in MTC (machine-type-communication).

There may be considered a radio node adapted for performing any one of the methods for operating a radio node described herein. It may be considered that a radio node is adapted for transmitting as well as decoding, to enable two-way communication using the prescribed approach. In this case, the transmission parameters and/or resources for transmitting may be different from those for receiving.

There may be considered a user equipment adapted for performing any one of the methods for operating a radio node/user equipment described herein.

There is also disclosed a program product comprising code executable by control circuitry, the code causing the control circuitry to carry out and/or control any one of the method for operating a user equipment or radio node as described herein, in particular if executed on control circuitry, which may be control circuitry of a user equipment or a radio node as described herein.

Moreover, there is disclosed a carrier medium arrangement carrying and/or storing at least any one of the program products described herein and/or code executable by control circuitry, the code causing the control circuitry to perform and/or control at least any one of the methods described herein. A carrier medium arrangement may comprise one or more carrier media. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A user equipment configured with a certain configuration (or according to control information) may be set and/or operational according to the configuration or based on the control information and/or the transmission parameters and/or radio resources indicated by the control information; the configuration may be configured by a network and/or network node, e.g. by transmitting corresponding information (the information may represent the configuration), and/or by itself, e.g. based on determining and/or deciding and/or allocating the resources and/or parameters.

Configuring a radio node or terminal or UE, e.g. by a network or network node, may comprise transmitting, by the network or network node, one or more parameters and/or commands and/or allocation or control data to the radio node or terminal or UE, and/or the terminal or UE changing its configuration and/or setup, e.g. based on received parameters and/or commands and/or allocation data from the network and/or the network node.

A user equipment (UE) may generally be a device configured for wireless device-to-device communication (it may be a D2D device) and/or a terminal for a wireless and/or cellular network, in particular a mobile terminal, for example a mobile phone, smart phone, tablet, PDA, etc. A user equipment may be a node of or for a wireless communication network as described herein. It may be envisioned that a user equipment or D2D device is adapted for one or more RATs, in particular LTE/E-UTRA. A user equipment may generally be proximity services (ProSe) enabled, which may mean it is D2D capable or enabled. It may be considered that a user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A node or device of or for a wireless communication network may generally be a user equipment or D2D device. It may be considered that a user equipment is configured to be a user equipment adapted for and/or according to LTE/E-UTRAN. Generally, the terms ProSe, D2D, device-to-device and peer-to-peer communication may be used interchangeably.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

A radio node or network device or node or a user equipment may be or comprise a software/program arrangement arranged to be executable by a hardware device, e.g. control circuitry, and/or storable in a memory, which may provide corresponding control functionality and/or control functionality to carry out any one of the methods described herein and/or to implement any one or more than one functionalities of a radio node or user equipment and/or network node described herein.

Radio spectrum: Although at least some of the embodiments may be described for D2D transmissions in the UL spectrum (FDD) or UL resources (TDD), the embodiments are not limited to the usage of UL radio resources, neither to licensed or unlicensed spectrum, or any specific spectrum at all.

A cellular network or mobile or wireless communication network may comprise e.g. an LTE network (FDD or TDD), UTRA network, CDMA network, WiMAX, GSM network, any network employing any one or more radio access technologies (RATS) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

Each or any one of the radio nodes or user equipments shown in the figures may be adapted to perform the methods to be carried out by a radio node or user equipment described herein. Alternatively or additionally, each or any of the radio nodes or user equipments shown in the figures may comprise any one or any combination of the features of a user equipment described herein.

In this description, for purposes of explanation and not limitation, specific details are set forth (such as particular network functions, processes and signalling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

1. A method for operating a radio node, the radio node being adapted for Device-to-Device (D2D) communication, the method comprising:
transmitting a data packet, the data packet comprising control information and data, the control information pertaining to the data.

2. The method according to claim 1, wherein the data packet comprises at least one control field and at least one data field.

3. The method according to claim 1, wherein the at least one control field and/or the control information is encoded for error checking and/or error detection.

4. The method according to claim 1, wherein a first control field contains control information pertaining to a second control field and/or a data field.

5. The method according to claim 1, wherein control information indicates one or more transmission parameters and/or radio resources used or intended for use for transmitting the data or data field.

6. A method for operating a radio node, the radio node being adapted for Device-to-Device (D2D) communication, the method comprising decoding a data packet, wherein the data packet may comprise control information and data, the control information pertaining to the data.

7. The method according to claim 6, wherein the data packet comprises at least one control field and at least one data field.

8. The method according to claim 6, wherein decoding comprises decoding of a data field of the data packet based on control information indicated by or in, and/or contained in, one or more control fields of the data packet.

9. The method according to claim 6, wherein decoding of a control field of the data packet comprises blind decoding of a control field of the data packet.

10. A radio node for a wireless communication network, the radio node being adapted for Device-to-Device (D2D) communication, the radio node being adapted to:
transmit a data packet, the data packet comprising control information and data, the control information pertaining to the data.

11-12. (canceled)

13. The radio node of claim 10, wherein the data packet comprises at least one control field and at least one data field.

14. The radio node of claim 10, wherein the at least one control field and/or the control information is encoded for error checking and/or error detection.

15. The radio node of claim 10, wherein a first control field contains control information pertaining to a second control field and/or a data field.

16. The radio node of claim 10, wherein control information indicates one or more transmission parameters and/or radio resources used or intended for use for transmitting the data or data field.

17. The radio node of claim 10 wherein the radio node is adapted for D2D communication, and the radio node is further adapted to decode a data packet, wherein the data packet may comprise control information and data, the control information pertaining to the data.

18. The radio node of claim 17, wherein the data packet comprises at least one control field and at least one data field.

19. The radio node of claim 17, wherein decoding comprises decoding of a data field of the data packet based on control information indicated by or in, and/or contained in, one or more control fields of the data packet.

20. The radio node of claim 17, wherein decoding of a control field of the data packet comprises blind decoding of a control field of the data packet.

21. A non-transitory computer readable medium comprising instructions executable by a processor of a radio node adapted for Device-to-Device (D2D) communication to thereby cause the radio node to:
transmit a data packet, the data packet comprising control information and data, the control information pertaining to the data.
